(19) United States
(12) Patent Application Publication
(10) Pub. No.: US 2026/0364389 A1
(43) Pub. Date: Nov. 19, 2026

(54) FIRE MANAGEMENT WITH PROACTIVE MEASURES

(71) Applicant: International Business Machines Corporation, Armonk, NY (US)

(72) Inventors: Nancy AFANDI, San Ramon, CA (US); Emily CHAN, Millbrae, CA (US); Ho-Yiu LAM, Mountain View, CA (US)

(21) Appl. No.: 19/210,613

(22) Filed: May 16, 2025

(51) Int. Cl. A62C 3/02; G01W 1/02; G05D 1/689; G06K 19/07; G06T 7/00; G05D 105/55; G05D 105/80; G05D 107/20; G05D 109/20; G05D 111/10; G05D 111/30

(52) U.S. Cl. CPC A62C 3/0292; A62C 3/0271; G01W 1/02; G05D 1/689; G06K 19/0723; G06T 7/0012; G05D 2105/55; G05D 2105/80; G05D 2107/21; G05D 2109/20; G05D 2111/10; G05D 2111/34; G06T 2207/10032; G06T 2207/30188

(57) ABSTRACT

In some implementations, a computing device detects, using a sensor network that includes multiple sensors distributed within a geographical region, an environmental condition that indicates a potential fire threat to the geographical region, the multiple sensors comprising one or more temperature sensors, one or more humidity sensors, and one or more smoke sensors. The computing device validates the potential fire threat using an unmanned aerial vehicle that includes an imaging capability and a computer vision capability. The computing device activates, based at least in part on the validating, a water-based suppression system that is integrated with an agricultural irrigation infrastructure, the activating comprising using a control mechanism that is configured to balance water application for fire suppression with water damage mitigation.

### BACKGROUND

The threat of uncontrolled fires poses a significant risk to various industries, including agriculture, where the impact can be devastating and long-lasting.

### SUMMARY

Some aspects described herein relate to a method. The method may include detecting, using a sensor network that includes multiple sensors distributed within a geographical region, an environmental condition that indicates a potential fire threat to the geographical region, the multiple sensors comprising one or more temperature sensors, one or more humidity sensors, and one or more smoke sensors. The method may include validating the potential fire threat using an unmanned aerial vehicle (UAV) that includes an imaging capability and a computer vision capability. The method may include activating, based at least in part on the validating, a water-based suppression system that is integrated with an agricultural irrigation infrastructure, the activating comprising using a control mechanism that is configured to balance water application for fire suppression with water damage mitigation.

Some aspects described herein relate to a computer system. The computer system may include a processor set, one or more computer-readable storage media, and program instructions stored on the one or more computer-readable storage media to cause the processor set to perform operations. The operations may include monitoring for a potential fire threat using first sensor data from a sensor network that is deployed within a geographical area, the sensor network comprising one or more temperature sensors, one or more humidity sensors, and one or more smoke sensors. The operations may include detecting the potential fire threat based at least in part on the first sensor data. The operations may include deploying, based at least in part on detecting the potential fire threat, a UAV to a location associated with the potential fire threat. The operations may include receiving, from the UAV, validation of the potential fire threat. The operations may include managing, using second sensor data from the UAV, a water-based suppression system that is integrated with an agricultural irrigation infrastructure to mitigate the potential fire threat and to mitigate water damage.

Some aspects described herein relate to a computer program product. The computer program product may include one or more computer-readable storage media and program instructions stored on the one or more computer-readable storage media to perform operations. The operations may include detecting, using a sensor network that includes multiple sensors distributed within a geographical region, an environmental condition that indicates a potential fire threat to the geographical region, the multiple sensors comprising one or more temperature sensors, one or more humidity sensors, and one or more smoke sensors. The operations may include validating the potential fire threat using an imaging capability and a computer vision capability in a mobile computing device. The operations may include using a control mechanism to activate a water-based suppression system that is integrated with an agricultural irrigation infrastructure, the control mechanism configured to balance water application by the water-based suppression system with water damage mitigation. The operations may include managing the water-based suppression system to adjust a water pressure based on intensity data indicating an intensity of the potential fire threat.

### BRIEF DESCRIPTION OF THE DRAWINGS

FIG. 1 is a diagram of an example computing environment for fire threat management using UAVs, sensor networks, and water suppression systems integrated with an irrigation infrastructure.

FIG. 2 is a diagram of an example of a system associated with fire threat management using unmanned aerial vehicles, sensor networks, and water suppression systems integrated with an irrigation infrastructure.

FIG. 3 is a diagram of example components of a device associated with fire threat management using unmanned aerial vehicles, sensor networks, and water suppression systems integrated with an irrigation infrastructure.

FIG. 4 is a flowchart of an example process associated with fire threat management using unmanned aerial vehicles, sensor networks, and water suppression systems integrated with an irrigation infrastructure.

### DETAILED DESCRIPTION

The following detailed description of example implementations refers to the accompanying drawings. The same reference numbers in different drawings may identify the same or similar elements.

Fire is a destructive force that has the potential to ravage homes, communities, and ecosystems. For example, fire may cause irreparable damage to property, infrastructure, and the environment, in addition to posing a threat to human and animal lives. Some forms of fire, such as wildfire, may be unpredictable, which may impede effective prevention and mitigation efforts. To illustrate, a wildfire may sweep across vast areas of land, and the rate at which the wildfire spreads may be accelerated by a combination of factors such as strong winds, dry conditions, and combustible vegetation.

As one example, wildfires in an agricultural setting may result in crop loss, damage to farm infrastructure and equipment, and loss of life. As another example, wildfires in residential areas may lead to property damage, displacement of residents, and strain on local emergency services. Some fire suppression systems may rely on manual intervention, such as manual activation of sprinkler systems or dispatching of firefighting personnel, which may be slow and ineffective in responding to rapidly spreading fires. With regard to an agricultural fire, the manual fire suppression systems may not be equipped to address the challenges of agricultural fires, such as balancing fire suppression with water conservation and crop protection, resulting in unnecessary damage to crops and farm infrastructure.

Some implementations described herein provide a system for detecting and mitigating potential fire threats using at least a water-based suppression system, such as a water-based suppression system that is integrated with an irrigation system. In some aspects, the system may receive sensor data from a sensor network that includes multiple sensors that are distributed within a geographical region. Example sensors in the sensor network may include one or more temperature sensors, one or more humidity sensors, and one or more smoke sensors. Accordingly, the sensor network may include multiple types of sensors. The system may validate the potential fire threat using a mobile computing device, such as UAV that includes an imaging capability and a computer vision capability. “Computer vision capability” denotes a computer-based capability to interpret and understand visual information from digital images or videos (e.g., through the use of artificial intelligence), such as an ability to recognize objects, classify objects, and make decisions based on visual data. In some cases, the system may activate a water-based suppression system that is integrated with an agricultural irrigation infrastructure. Alternatively, or additionally, the system may adjust the water pressure in the water-based suppression system based on intensity data that indicates a strength of the potential fire threat and/or plant type information to mitigate damage to the type of plant.

The system may be centralized, through the use of a controller computer device, and/or may be distributed among multiple computing devices. For example, a controller computer device may manage various stages of detecting a potential fire threat, activating a water-based suppression system, and adjusting operation of the water-based suppression system, such as by instructing various devices to obtain sensor data, validate a potential fire threat, activate a water-based suppression system, and/or adjust operation of the water-based suppression system. Alternatively, or additionally, in a distributed system, multiple computer devices may work together to perform these functions, with each device processing sensor data, controlling specific components of the water-based suppression system, or coordinating validation (e.g., using UAV imaging and computer vision capabilities) of the potential fire threat to optimize suppression efforts.

The integrated use of sensor data to detect a potential fire threat, computer vision to validate the potential fire threat, and automation of a water-based suppression system (e.g., a water-based suppression system that leverages an existing irrigation system or a fire suppression water-based system) may provide a rapid, efficient, and resource-effective process to mitigate fire threats, such as unpredictable wildfire threats in an agricultural setting. By integrating with existing agricultural irrigation infrastructure, the system leverages existing water resources and mitigates strain on local water supplies. Alternatively, or additionally, by deploying a distributed network of sensors and utilizing UAV imaging and computer vision capabilities for validation, the system may reduce a computational overhead associated with real-time threat detection. To illustrate, the integration and automation may reduce response times, optimize resource allocation, and provide real-time monitoring and suppression capabilities. For instance, in agricultural settings, the system may mitigate crop loss, damage to farm infrastructure and equipment, and loss of life by rapidly detecting potential fire threats and automating the activation of a water-based suppression system. The system may also reduce an amount of strain on local emergency services and reduce manual intervention. Alternatively, or additionally, the system may protect crops in an agricultural setting by balancing fire suppression with water conservation and crop protection. In residential and commercial areas, the system may mitigate loss of life, reduce property damage, mitigate displacement of residents, and reduce a strain on local emergency services by providing a rapid and automated means of detecting and suppressing fires (e.g., by automating the activation of a water-based suppression system, enabling a rapid response from fire responders, or both).

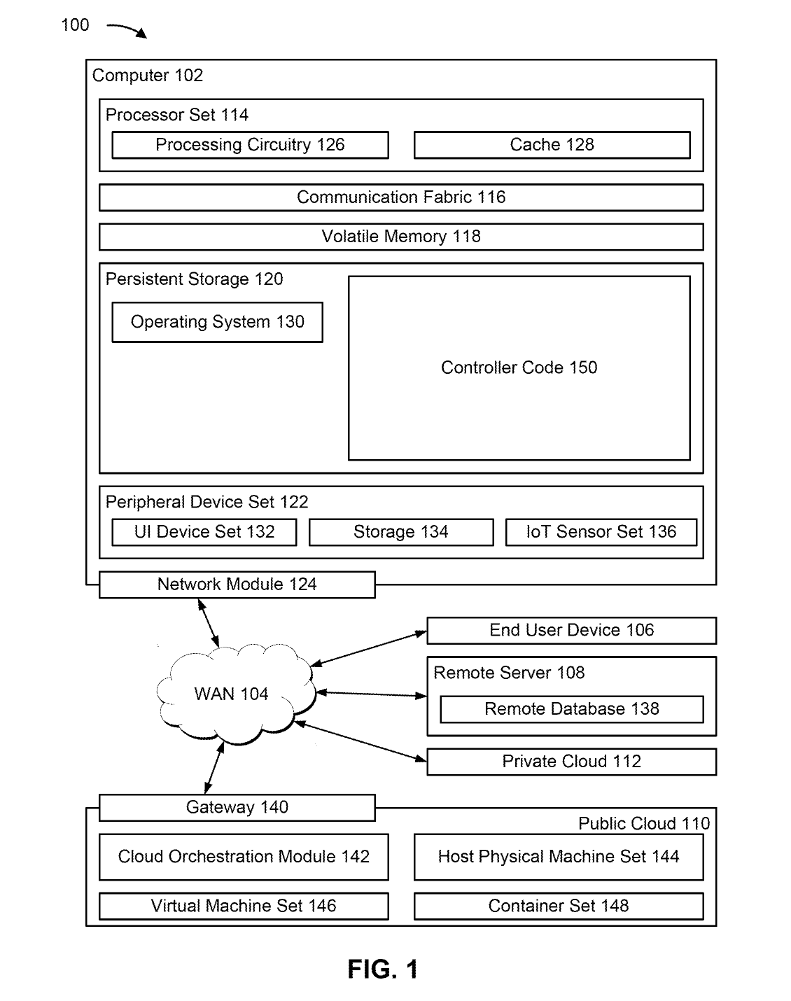

FIG. 1 is a diagram of an example computing environment 100 for fire threat management using unmanned aerial vehicles, sensor networks, and water suppression systems integrated with irrigation infrastructure brief description of the drawings described herein.

The computing environment 100 contains an example of an environment for the execution of at least some of the computer code involved in performing the inventive methods, such as controller code 150. In addition to the controller code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the controller code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in controller code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the controller code 150 typically includes at least some of the computer code involved in performing one or more operations described herein. The operations may include, for example, detecting, using a sensor network that includes multiple sensors distributed within a geographical region, an environmental condition that indicates a potential fire threat to the geographical region, the multiple sensors including one or more temperature sensors, one or more humidity sensors, and one or more smoke sensors; validating the potential fire threat using a UAV that includes an imaging capability and a computer vision capability; and activating, based at least in part on the validating, a water-based suppression system that is integrated with an agricultural irrigation infrastructure, the activating including using a control mechanism that is configured to balance water application for fire suppression with water damage mitigation.

In some implementations, the operations may include monitoring for a potential fire threat using first sensor data from a sensor network that is deployed within a geographical area, the sensor network including one or more temperature sensors, one or more humidity sensors, and one or more smoke sensors; detecting the potential fire threat based at least in part on the first sensor data; deploying, based at least in part on detecting the potential fire threat, a UAV to a location associated with the potential fire threat; receiving from the UAV, validation of the potential fire threat; and managing, using second sensor data from the UAV, a water-based suppression system that is integrated with an agricultural irrigation infrastructure to mitigate the potential fire threat and to mitigate water damage.

In some implementations, the operations may include detecting, using a sensor network that includes multiple sensors distributed within a geographical region, an environmental condition that indicates a potential fire threat to the geographical region, the multiple sensors including one or more temperature sensors, one or more humidity sensors, and one or more smoke sensors; validating the potential fire threat using an imaging capability and a computer vision capability in a mobile computing device; using a control mechanism to activate a water-based suppression system that is integrated with an agricultural irrigation infrastructure, the control mechanism configured to balance water application by the water-based suppression system with water damage mitigation; and managing the water-based suppression system to adjust a water pressure based on intensity data indicating an intensity of the potential fire threat.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer, and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

While the controller code 150 is illustrated by FIG. 1 as residing on a single computer 102, the controller code 150 may be distributed across multiple computers 102 in other examples. For instance, the controller code 150 may be distributed in a decentralized manner, where multiple computers 102 work together to perform various operations described herein. To illustrate, the controller code 150 may be distributed across multiple computers 102, with each computer 102 performing one or more respective operations used in different stages of detecting a potential fire threat, validating the potential fire threat, and activating a water-based suppression system. Alternatively, or additionally, the controller code 150 may be distributed across one or more computers 102 that respectively control a specific component of the water-based suppression system, such as a network of sprinklers, to mitigate fire threats in different areas of a farm. Distributing the controller code 150 across multiple computers 102 may enable the system to scale and manage large and complex fire mitigation scenarios, while maintaining high performance and reliability.

FIG. 1 is provided as an example. Other examples may differ from what is described with regard to FIG. 1.

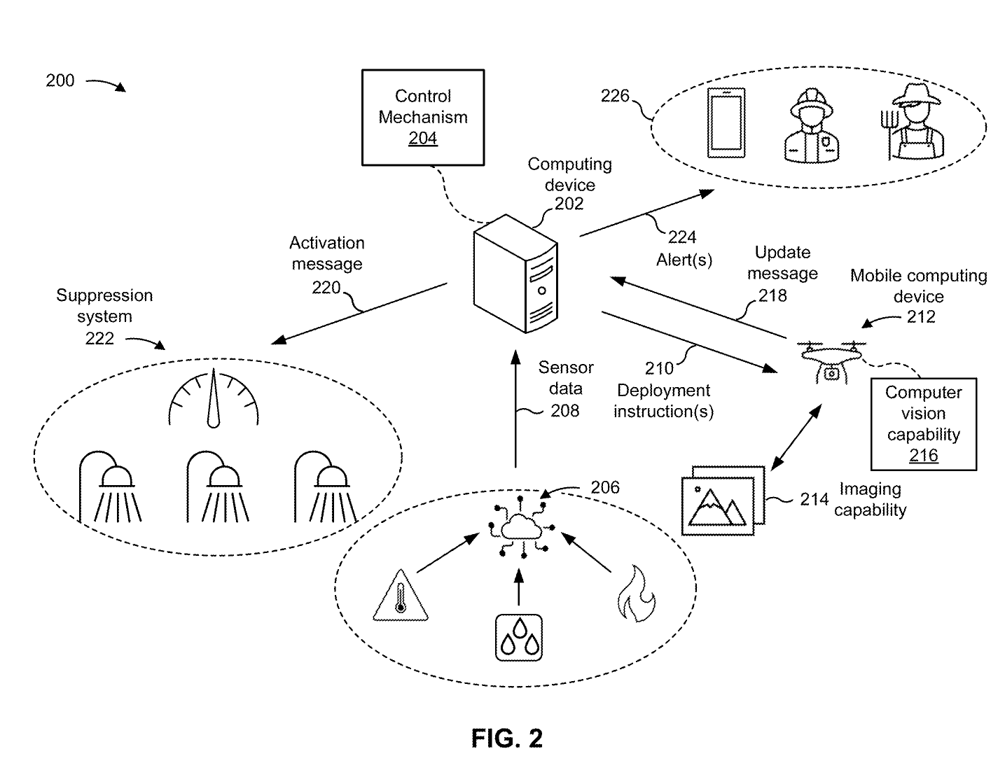

FIG. 2 is a diagram of an example 200 of a system associated with fire threat management using unmanned aerial vehicles, sensor networks, and water suppression systems integrated with irrigation infrastructure. The example 200 shown by FIG. 2 includes a computing device 202 (e.g., a computer 102) that includes a control mechanism 204. In some aspects, the control mechanism 204 includes a software-based controller that manages the various components of the system, such as the control code 150 described with regard to FIG. 1. Example components include a sensor network, a mobile computing device (e.g., a UAV), a network of sprinklers, and irrigation infrastructure. For clarity, FIG. 2 illustrates the control mechanism 204 as residing on a single computing device (e.g., the computing device 202), but other examples may include the control mechanism 204 being distributed among multiple computing devices, such as IoT devices, edge devices, mobile computing devices, UAVs, sensor nodes, sprinklers, and other computing devices within the system.

The control mechanism 204, by way of the computing device 202, may communicate with various devices and systems within the system described with regard to the example 200 using a range of communication protocols and technologies to exchange data, commands, and control signals with these devices and systems. Examples include the computing device 202, the control mechanism 204, or both, being configured to use wireless communication protocols (e.g., a Long Range Wide Area Network (LoRaWAN), Wi-Fi, or Bluetooth), cellular networks (e.g., 4G, 5G), or other data exchange protocols (e.g., Message Queuing Telemetry Transport (MQTT) or CoAP (Constrained Application Protocol)). The control mechanism 204 and/or the computing device 202 may communicate directly with devices, such by directly communicating with a mobile computing device (e.g., a UAV) using a cellular network or a LoRaWAN, or indirectly by instructing another device (e.g., the mobile computing device) to gather data or to transmit commands, thus enabling the control mechanism 204 to manage and control the various components of the system in a flexible and scalable manner.

To illustrate, the system 200 includes a sensor network 206 that includes multiple sensors that are distributed within a geographical region (e.g., a farm or a building). Examples of sensors within the sensor network 206 include one or more temperature sensors, one or more humidity sensors, one or more smoke sensors, and/or one or more wind sensors (e.g., anemometers) which may be used to detect environmental conditions that indicate a potential fire threat. In some cases, at least one of the sensors may be implemented as an IoT device. The computing device 202, by way of the control mechanism 204, may communicate with one or more sensors in the sensor network 206 to obtain sensor data 208 using various communication protocols and technologies. For example, the computing device 202 may use a wireless communication protocol, such as Wi-Fi, Bluetooth, or LoRaWAN, or a wired connection, such as an Ethernet cable or a USB connection, to receive sensor data 208 from the sensor network 206. Alternatively, or additionally, the computing device 202 may communicate with the sensor network 206 using a decentralized communication protocol, such as a blockchain-based protocol or a data exchange protocol (e.g., MQTT or CoAP) to receive sensor data 208 from the sensor network 206. The various communication protocols and technologies may enable the computing device 202 and the control mechanism 204 to obtain sensor data 208 from the sensor network 206 in a reliable and efficient manner.

The control mechanism 204 may process the sensor data 208 to identify or detect one or more environmental conditions that indicate a potential fire threat, such as by comparing the sensor data 208 to one or more thresholds. Example environmental conditions that indicate a potential fire threat include temperatures that satisfy a temperature threshold, relative humidity that satisfies a humidity threshold, and smoke levels that satisfy a smoke threshold, as well as rapid rises in temperature over a short time window (e.g., 10 minutes), dry conditions, and combinations of high temperatures and low humidity. For example, the control mechanism 204 may compare temperature sensor data from one or more temperature sensors to a temperature threshold, such as 80°Celsius. The temperature sensor data satisfying the temperature threshold may indicate the potential of a fire threat, and the temperature sensor data failing to satisfy the temperature threshold may indicate a lack of potential for the fire threat. To illustrate, a rise in temperature over a time window of 10 minutes may indicate a rapidly spreading fire, while a lack of rise over the same time window may indicate a low risk of fire. Alternatively, or additionally, the control mechanism 204 may compare humidity data from one or more humidity sensors to a humidity threshold, such as 20% relative humidity. As an example, humidity sensor data that satisfies the humidity threshold (e.g., falls below the humidity threshold) may indicate a heightened risk of fire due to dry conditions, and humidity sensor data that fails to satisfy the humidity threshold (e.g., exceeds the humidity threshold) may indicate a lower risk of fire due to more moist conditions. As another example, the control mechanism 204 may compare smoke data from one or more smoke sensors to a smoke threshold, such as 500 micrograms per cubic meter (μg/m³). In some cases, smoke levels that satisfy the smoke threshold (e.g., exceeds the smoke threshold) may indicate a fire in progress, and smoke levels that fail to satisfy the smoke threshold (e.g., fall below the smoke threshold) may indicate a low risk of fire. Alternatively, or additionally, the control mechanism 204 may compare wind data from one or more wind sensors to a wind threshold, such as 30 kilometers per hour (km/h). Wind speeds that satisfy the wind threshold (e.g., exceed the wind threshold) may indicate a heightened risk of fire spread due to strong winds, and wind speeds that fail to satisfy the wind threshold may indicate a lower risk of fire spread. The control mechanism 204 may analyze combinations of sensor data, such as any combination of temperature data, humidity data and/or wind data to determine whether the environmental condition(s) indicate a potential fire threat. In some aspects, the computing device 202 may receive weather data (e.g., temperature, humidity, and wind conditions) from one or more external sources to the sensor network 206. Examples of external sources include public weather APIs, meteorological satellites, national meteorological services, local weather stations, climate data repositories, and IoT devices. The computing device 202 and/or the control mechanism 204 may use the weather data in a similar manner as sensor data to identify a potential fire threat. Using this weather data, the device generates a prediction of the next potential fire threat and/or a fire pattern prediction by analyzing patterns and environmental conditions that are conducive to fire spread. This predictive capability allows the system to proactively deploy suppression measures and alert relevant entities to mitigate the fire threat before it escalates.

Based at least in part on determining that an environmental condition indicates a potential fire threat, the control mechanism 204 may send, by way of the computing device 202, a deployment instruction 210 to a mobile computing device 212, which is illustrated by FIG. 2 as a UAV. Other examples may include autonomous ground vehicles, or other types of mobile devices equipped with sensors and communication capabilities. The deployment instruction 210 may indicate a deployment location associated with a potential fire threat and/or may indicate an instruction to validate the existence and/or extent of the potential fire threat. As described above, the control mechanism 204 and/or the computing device 202 may send the deployment instruction 210 using various communication protocols and technologies. While the example 200 includes a single mobile computing device 212 receiving the deployment instruction 210, other examples may include multiple mobile computing devices 212 receiving the deployment instruction, such as through direct messaging or broadcast messaging, allowing for a coordinated response to a potential fire threat.

The mobile computing device 212 may include an imaging capability 214, such as a camera or sensor, that allows it to capture images or video of the environment. Alternatively, or additionally, the mobile computing device 212 may include a computer vision capability 216, such as software or algorithms that process and interpret visual data captured by the imaging capability 214. The computer vision capability 216 may include object detection, image recognition, and other techniques that allow the mobile computing device 212 to analyze the visual data and validate (or invalidate) a potential fire threat. To illustrate, the mobile computing device 212 may capture images or videos at a deployment location indicated in the deployment instruction 210, and may use the computer vision capability 216 to analyze the images or videos to validate that the potential fire threat is present. For example, the computer vision capability 216 may be trained using machine learning algorithms and a dataset of images and videos of fires, which enables the mobile computing device 212 to recognize patterns and characteristics of fires and accurately validate or invalidate the potential fire threat.

In some aspects, the mobile computing device 212 may gather additional sensor data from the sensor network 206, such as temperature, humidity, and wind data, to validate or invalidate the potential fire threat. For example, the mobile computing device 212 may communicate with one or more sensors by using wireless communication protocols such as Wi-Fi, Bluetooth, or LoRaWAN. Alternatively, or additionally, the mobile computing device 212 may receive weather data from one or more external sources to the sensor network 206 in a similar manner as described with regard to the computing device 202 and/or the control mechanism 204.

In some cases, the mobile computing device 212 may use the sensor data and/or weather data as input to a machine learning (ML) algorithm and/or artificial intelligence (AI) to generate a prediction of a next potential fire threat. For instance, the mobile computing device 212 may include a machine learning model that was trained using a dataset of sensor data, including temperature, humidity, wind, and other environmental factors, as well as visual data from the imaging capability 214. That is, the machine learning model may be trained to recognize patterns and characteristics that are indicative of a potential fire threat, such as high temperatures, low humidity, and strong winds. Alternatively, or additionally, the machine learning model at the mobile computing device 212 may be trained to use the sensor data and predict the likelihood of a next potential fire threat and/or a location of the next potential fire threat. For example, based at least in part on validating the potential fire threat, the mobile computing device 212 may use the additional sensor data obtained from the sensor network 206 and/or weather data obtained from external sources as input to the machine learning model. Using the input, the machine learning model may predict that the fire is likely to spread to a nearby area due to strong winds and dry conditions, or that a fire is likely to intensify due to increasing temperatures and low humidity. Alternatively, or additionally, the machine learning model at the mobile computing device 212 may be trained to generate a map of the prediction, such as by generating a geofencing map that outlines the next potential fire threat and/or delineates fire containment zones. Generating a prediction of a next potential fire threat may enable the mobile computing device 212 to provide an early warning and enable proactive measures to be taken to prevent or mitigate the fire. While the mobile computing device 212 may generate the prediction of the next potential fire threat, other examples include the mobile computing device 212 forwarding images, video, the additional sensor data, and/or weather data to the computing device 202 to enable the computing device 202 to generate the prediction of the next potential fire threat.

As shown by FIG. 2, the mobile computing device 212 may send an update message 218 to the control mechanism 204 and/or the computing device 202. In some cases, the update message may indicate a validation result (e.g., validation or invalidation of the potential fire threat). Alternatively, or additionally, the update message 218 may include any combination of visual data, sensor data, and/or a prediction of a next potential fire threat. For example, the update message 218 may include images or video captured by the imaging capability 214. In some cases, the update message 218 may include a prediction of a next potential fire threat generated by the mobile computing device 212 using machine learning algorithms or AI. Alternatively, or additionally, the update message 218 may include geofencing information, such as a geofencing map that outlines an area of the next potential fire threat and/or delineates fire containment zones. In some aspects, the update message 218 may include the additional sensor data gathered by the mobile computing device 212, such as temperature, humidity, and wind data, that enables the computing device 202 to generate a prediction of a next potential fire threat. By enabling the computing device 202 to generate a prediction of a next potential fire threat, the system 200 may conserve resources on the mobile computing device 212, such as battery life and processing power, while leveraging the greater resources of the computing device 202 to perform more complex tasks, such as predictive analytics and machine learning. The update message 218 may be sent using various communication protocols and technologies, examples of which are provided above.

Based at least in part on receiving the update message 218, and the update message 218 validating a presence of a fire threat, the control mechanism 204 may send, by way of the computing device 202, an activation message 220. In some examples, as shown by FIG. 2, the control mechanism 204 sends the activation message 220 directly to a suppression system 222. Other examples may include the control mechanism 204 instructing the mobile computing device 212 to interact with the suppression system 222, such as by transmitting an instruction to the mobile computing device 212 to activate specific sprinkler heads using radio frequency identification (RFID) and antenna technology. To illustrate, the suppression system 222 may include a network of sprinklers integrated with an irrigation system, and each sprinkler may include a respective RFID tag and antenna that enable the control mechanism 204 or the mobile computing device 212 to identify and activate specific sprinklers using RFID signals. The use of RFID signals and antenna technology enables the control mechanism 204 to activate or deactivate particular sprinklers within the suppression system 222, either directly or indirectly via the mobile computing device 212, to target the suppression efforts and minimize damage to crops and infrastructure. For example, the control mechanism 204 may use the RFID signals (e.g., directly or indirectly) to activate sprinklers in a specific area or zone, such as a zone that is closest to the detected fire threat, while leaving other sprinklers inactive. This targeted approach may conserve water and minimize the impact of the suppression efforts on the surrounding environment.

In some aspects, the control mechanism 204 may use plant type information to regulate a water pressure of the suppression system 222 to balance fire suppression efforts with mitigating damage to the surrounding environment. For example, the control mechanism 204 may be preprogrammed with plant type information (e.g., respective plant type information for respective regions of a geographical region) or may receive plant type information from the mobile computing device 212 (e.g., derived via the computer vision capability 216 and in the update message 218). The control mechanism 204 may determine that the affected area includes a plant type (e.g., crop) sensitive to overwatering, such as wheat or corn. In such a scenario, the control mechanism 204 may reduce the water pressure directly, or instruct the mobile computing device 212 to reduce the water pressure by transmitting an instruction to adjust the water pressure using the RFID signals controlling the suppression system 222, to prevent damage to the crops. Conversely, the plant type information may indicate a plant type more resilient to water, such as grass or soybeans, and the control mechanism 204 may increase the water pressure (e.g., directly or indirectly) to more effectively combat the fire threat. By taking into account the specific needs and characteristics of the plants in the affected area, the system may balance mitigating the potential fire threat with mitigating damage to crops.

Based at least in part on a prediction of a next potential fire threat, the control mechanism 204 may proactively activate sprinklers in zone(s) within the suppression system 222 that are identified by the next potential fire threat, thereby preventing the spread of the fire and minimizing damage to the surrounding environment. For example, the control mechanism 204 may use any combination of images, video, the additional sensor data, and/or weather data (e.g., forwarded by the mobile computing device 212) to generate a prediction of the next potential fire threat and/or a fire pattern prediction in a similar manner as described above. The control mechanism 204 may use the fire pattern prediction to identify one or more water suppression zones to activate as a proactive measure. By activating these zones in advance, the system may create a fire break or containment area, resulting in a reduced impact of the predicted fire threat. A proactive approach may also reduce the risk of the fire spreading to other areas, protecting crops, infrastructure, people, and animals in the surrounding region. As another example, the control mechanism 204 may use the fire pattern prediction to identify a predicted path of the fire and/or a strategic location to position a firebreak to mitigate a fire spreading. Accordingly, the control mechanism 204 may deploy one or more mobile computing devices, such as one or more unmanned harvesting vehicles, to clear crops in the predicted path of the next potential fire threat or the strategic location. For instance, an unmanned harvesting vehicle or unmanned farming equipment vehicle may be guided by geofencing information or coordinates (e.g., received from the control mechanism 204) to create firebreaks or fire lines (e.g., by clearing crops, rototilling earth, or digging a trench) that prevent a fire from spreading. Accordingly, the control mechanism 204 may send a deployment instruction to a mobile computing device (e.g., an unmanned harvesting vehicle or a UAV) that includes geofencing information or coordinates to the unmanned harvesting vehicles to proactively clear vegetation, contain the fire, minimize crop loss, and protect farm infrastructure.

In some cases, the control mechanism 204, by way of the computing device 202, may send one or more alerts 224 to one or more entities 226, such as one or more computing devices (e.g., a mobile phone, a laptop, a tablet, or a desktop computer) at a fire station, one or more computing devices of emergency response teams, or one or more computing devices of property owners (e.g., farmers or building owners), to provide a notification of a potential fire threat. In some aspects, the alert(s) 224 may indicate information about the potential fire threat, such as location, size, and intensity of the fire. The alerts 224 may be sent using various communication protocols and technologies, such as cellular networks, Wi-Fi, or satellite communication, and may include visual data, sensor data, and other relevant information collected by the system. For example, the control mechanism 204 may send an alert 224 to a farmer’s mobile device to provide real-time information about the fire and enabling immediate action to protect crops and property. Alternatively, or additionally, the alert(s) 224 may indicate information about a prediction of a next potential fire threat, enabling entities 226 to take proactive actions, such as creating fire lines or deploying firefighting resources, to prevent or mitigate the spread of the fire. By providing early warning of a potential next fire threat, the system may enable the entities 226 to deploy proactive actions ahead of the fire and reduce the risk of damage to crops, infrastructure, and the surrounding environment.

While the example 200 includes the computing device 202 sending the alerts 224 to the entities 226, other examples may include the mobile computing device 212 sending the alerts. For instance, the mobile computing device 212 may communicate the alert(s) 224 to the entities 226 via cellular networks, such as by sending text messages directly to computing devices at any combination of fire stations, farmers, and/or emergency response teams. As another example, the mobile computing device 212 may utilize satellite communication to ensure that alerts are delivered in remote areas where cellular coverage may be limited, or use local mesh networks to broadcast notifications to nearby devices in the affected area.

Fire threat management using unmanned aerial vehicles, sensor networks, and water suppression systems integrated with irrigation infrastructure may reduce losses due to fire, such as crops, buildings, and equipment, thereby minimizing economic impacts and environmental damage. The system also provides the ability to deploy proactive measures to be taken to mitigate next potential fires that may be predicted through the use of historical sensor data, current sensor data, artificial intelligence, and machine learning algorithms that analyze fire patterns and identify high-risk areas. Example proactive measures include creating a fire line or containment zone, early deployment of firefighting resources, and targeted watering of high-risk areas to prevent fires from spreading. That is, the system enables proactive containment, rather than just reactive suppression, by providing early detection of potential fire threats through real-time monitoring of sensor data and aerial imaging, thereby allowing for swift deployment of targeted suppression efforts and proactive measures to prevent the spread of fires. Additionally, the system balances fire mitigation with damage minimization by adjusting water pressure to prevent overwatering and mitigate damage to crops, thereby reducing the risk of crop loss and ensuring the continued health and productivity of the affected area.

FIG. 2 is provided as an example. Other examples may differ from what is described with regard to FIG. 2.

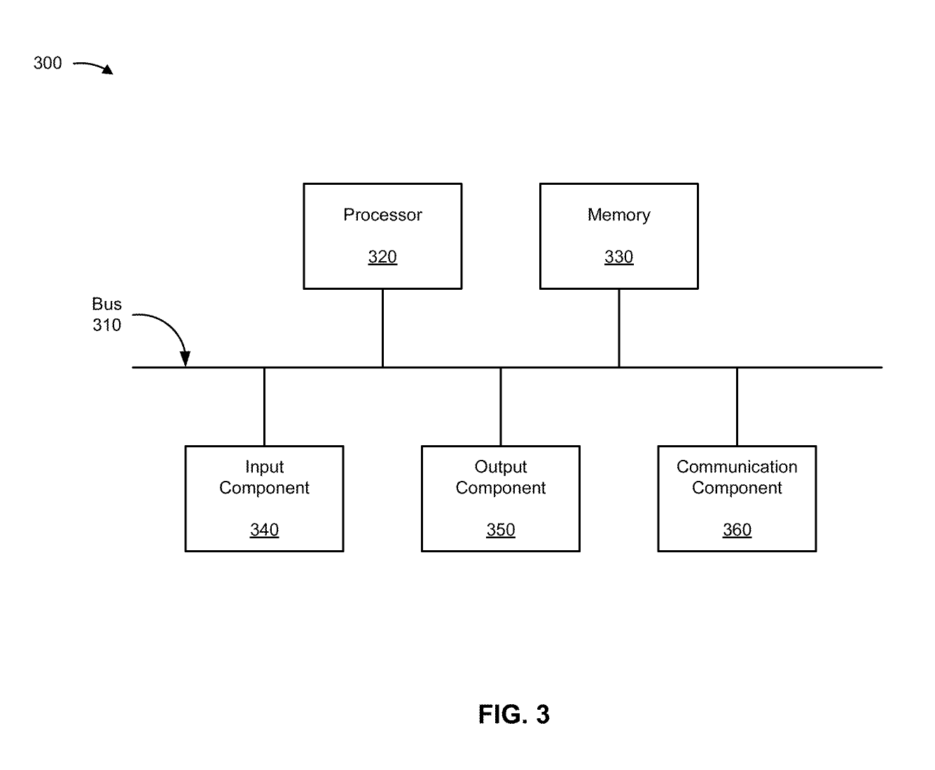

FIG. 3 is a diagram of example components of a device 300 associated with fire threat management using UAVs, sensor networks, and water suppression systems integrated with irrigation infrastructure. The device 300 corresponds to one or more of a computing device 202, a mobile computing device 212, or an IoT device (e.g., in a sensor network 206 or a suppression system 222). In some implementations, a computing device 202, a mobile computing device 212, or an IoT device include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random-access memory (RAM), read-only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Alternatively, or additionally, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

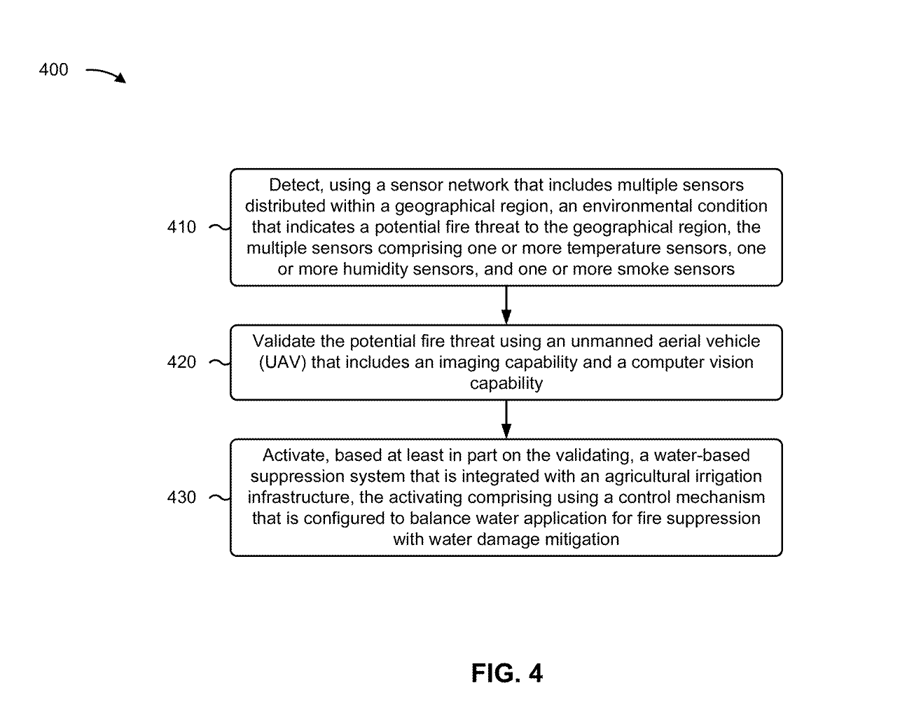

FIG. 4 is a flowchart of an example process 400 associated with fire threat management using UAVs, sensor networks, and water suppression systems integrated with irrigation infrastructure. One or more process blocks of FIG. 4 are performed by a device (e.g., computing device 202) and/or by another device or a group of devices separate from or including the device, such as a computing device (e.g., a computer 102 or a computing device 202), a mobile computing device (e.g., a mobile computing device 212), and/or an IoT device (e.g., in a sensor network 206 or a suppression system 222). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes detecting, using a sensor network that includes multiple sensors distributed within a geographical region, an environmental condition that indicates a potential fire threat to the geographical region, the multiple sensors including one or more temperature sensors, one or more humidity sensors, and one or more smoke sensors (block 410). For example, the device may detect, using a sensor network that includes multiple sensors distributed within a geographical region, an environmental condition that indicates a potential fire threat to the geographical region, the multiple sensors including one or more temperature sensors, one or more humidity sensors, and one or more smoke sensors, as described above.

As further shown in FIG. 4, process 400 includes validating the potential fire threat using a UAV that includes an imaging capability and a computer vision capability (block 420). For example, the device may validate the potential fire threat using a UAV that includes an imaging capability and a computer vision capability, as described above.

As further shown in FIG. 4, process 400 includes activating, based at least in part on the validating, a water-based suppression system that is integrated with an agricultural irrigation infrastructure, the activating including using a control mechanism that is configured to balance water application for fire suppression with water damage mitigation (block 430). For example, the device may activate, based at least in part on the validating, a water-based suppression system that is integrated with an agricultural irrigation infrastructure, the activating including using a control mechanism that is configured to balance water application for fire suppression with water damage mitigation, as described above.

Process 400 may include additional aspects, such as any single aspect or any combination of aspects described below and/or in connection with one or more other processes described elsewhere herein.

In a first aspect, the sensor network includes a LoRaWAN.

In a second aspect, process 400 includes computing, based at least in part on the imaging capability of the UAV, a predicted next fire threat that is associated with the potential fire threat.

In a third aspect, process 400 includes triggering a proactive measure configured to mitigate the predicted next fire threat.

In a fourth aspect, the computer vision capability of the UAV includes an object detection algorithm.

In a fifth aspect, the control mechanism includes a software-based controller.

In a sixth aspect, the control mechanism is configured to manage, as at least part of the water-based suppression system and the agriculture irrigation infrastructure, a network of sprinklers.

In a seventh aspect, each sprinkler in the network of sprinklers includes a respective RFID tag and a respective antenna, and activating the water-based suppression system includes activating one or more particular sprinklers in the network of sprinklers using the respective RFID tag and the respective antenna of each particular sprinkler of the one or more particular sprinklers.

In an eighth aspect, process 400 includes receiving intensity data that indicates an intensity of the potential fire threat, and adjusting a water pressure in the water-based suppression system based at least in part on the intensity data.

In a ninth aspect, adjusting a water pressure in the water-based suppression system includes instructing the UAV to transmit one or more control signals that instruct the water-based suppression system to adjust the water pressure.

In a tenth aspect, process 400 includes deploying the UAV based at least in part on first sensor data from the sensor network, and obtaining additional sensor data for the geographical region using the UAV, and the validating is based at least in part on the additional sensor data.

In an eleventh aspect, process 400 includes obtaining plant type information that indicates a type of plant that is located within the geographical region, and adjusting an amount of water that is applied as at least part of the fire suppression based at least in part on the plant type information to mitigate damage to the type of plant.

In a twelfth aspect, process 400 includes sending, via a communication network, an alert to one or more entities, the sending being based at least in part on the validating.

In a thirteenth aspect, the one or more entities include a fire station computing device, an emergency response computing device, or a computing device registered to receive the alert.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM) or Flash memory, static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
detecting, using a sensor network that includes multiple sensors distributed within a geographical region, an environmental condition that indicates a potential fire threat to the geographical region, the multiple sensors comprising one or more temperature sensors, one or more humidity sensors, and one or more smoke sensors;
validating the potential fire threat using an unmanned aerial vehicle (UAV) that includes an imaging capability and a computer vision capability; and
activating, based at least in part on the validating, a water-based suppression system that is integrated with an agricultural irrigation infrastructure, the activating comprising using a control mechanism that is configured to balance water application for fire suppression with water damage mitigation.

2. The method of claim 1, further comprising:
computing, based at least in part on the imaging capability of the UAV, a predicted next fire threat that is associated with the potential fire threat.

3. The method of claim 2, further comprising:
triggering a proactive measure configured to mitigate the predicted next fire threat.

4. The method of claim 1, wherein the control mechanism is configured to manage, as at least part of the water-based suppression system and the agriculture irrigation infrastructure, a network of sprinklers.

5. The method of claim 4, wherein each sprinkler in the network of the sprinklers comprises a respective radio frequency identification (RFID) tag and a respective antenna, and
wherein activating the water-based suppression system comprises:
activating one or more particular sprinklers in the network of the sprinklers using the respective RFID tag and the respective antenna of each particular sprinkler of the one or more particular sprinklers.

6. The method of claim 1, further comprising:
receiving intensity data that indicates an intensity of the potential fire threat; and
adjusting a water pressure in the water-based suppression system based at least in part on the intensity data.

7. The method of claim 6, wherein adjusting the water pressure in the water-based suppression system comprises:
instructing the UAV to transmit one or more control signals that instruct the water-based suppression system adjust the water pressure.

8. The method of claim 1, further comprising:
deploying the UAV based at least in part on first sensor data from the sensor network; and
obtaining additional sensor data for the geographical region using the UAV,
wherein the validating is based at least in part on the additional sensor data.

9. The method of claim 1, further comprising:
obtaining plant type information that indicates a type of plant that is located within the geographical region; and
adjusting an amount of water that is applied as at least part of the fire suppression based at least in part on the plant type information to mitigate damage to the type of plant.

10. The method of claim 1, further comprising:
sending, via a communication network, an alert to one or more entities, the sending being based at least in part on the validating.

11. A computer system comprising:
a processor set;
one or more computer-readable storage media; and
program instructions stored on the one or more computer-readable storage media to cause the processor set to perform operations comprising:
monitoring for a potential fire threat using first sensor data from a sensor network that is deployed within a geographical area, the sensor network comprising one or more temperature sensors, one or more humidity sensors, and one or more smoke sensors;
detecting the potential fire threat based at least in part on the first sensor data;
deploying, based at least in part on detecting the potential fire threat, an unmanned aerial vehicle (UAV) to a location associated with the potential fire threat;
receiving, from the UAV, validation of the potential fire threat; and
managing, using second sensor data from the UAV, a water-based suppression system that is integrated with an agricultural irrigation infrastructure to mitigate the potential fire threat and to mitigate water damage.

12. The computer system of claim 11, wherein the water-based suppression system comprises a network of sprinklers,
wherein each sprinkler in the network of sprinklers comprises a respective radio frequency identification (RFID) tag and a respective antenna, and
wherein the program instructions that cause the processor set to perform operations for managing the water-based suppression system are further configured to cause the processor set to perform operations comprising:
activating one or more sprinklers in the network of sprinklers using the respective RFID tag and the respective antenna of each sprinkler of the one or more sprinklers.

13. The computer system of claim 11, wherein the program instructions that cause the processor set to perform operations for managing the water-based suppression system are further configured to cause the processor set to perform operations comprising:
receiving intensity data that indicates a strength of the potential fire threat, and
adjusting a water pressure in the water-based suppression system based at least in part on the intensity data.

14. The computer system of claim 11, wherein the program instructions that cause the processor set to perform operations for managing the water-based suppression system are further configured to cause the processor set to perform operations comprising:
obtaining plant type information that indicates a type of plant that is located within the geographical area, and
adjusting an amount of water applied by the water-based suppression system based on the plant type information.

15. The computer system of claim 11, wherein the UAV includes an imaging capability and a computer vision capability, and
wherein the program instructions are further configured to cause the processor set to perform operations comprising:
directing the UAV to perform the validation of the potential fire threat using the imaging capability and the computer vision capability.

16. The computer system of claim 11, wherein the program instructions are further configured to cause the processor set to perform operations comprising:
computing a prediction of a next potential fire threat based on the first sensor data and the second sensor data from the UAV.

17. A computer program product comprising:
one or more computer-readable storage media; and
program instructions stored on the one or more computer-readable storage media to perform operations comprising:
detecting, using a sensor network that includes multiple sensors distributed within a geographical region, an environmental condition that indicates a potential fire threat to the geographical region, the multiple sensors comprising one or more temperature sensors, one or more humidity sensors, and one or more smoke sensors;
validating the potential fire threat using an imaging capability and a computer vision capability in a mobile computing device;
using a control mechanism to activate a water-based suppression system that is integrated with an agricultural irrigation infrastructure, the control mechanism configured to balance water application by the water-based suppression system with water damage mitigation; and
managing the water-based suppression system to adjust a water pressure based on intensity data indicating an intensity of the potential fire threat.

18. The computer program product of claim 17, wherein the program instructions include instructions to perform operations comprising:
predicting a next potential fire threat using at least sensor data from the sensor network; and
triggering a proactive measure to mitigate the next potential fire threat.

19. The computer program product of claim 18, wherein the proactive measure comprises at least one of:
activating the water-based suppression system at a location associated with the next potential fire threat and
sending an alert to an entity, the alert indicating a location of the next potential fire threat.

20. The computer program product of claim 17, wherein the program instructions include program instructions to perform operations comprising:
receiving weather data about the geographical region; and
predicting a next potential fire threat based at least in part on the weather data.
